(19) United States
(12) Patent Application Publication
(10) Pub. No.: US 2026/0302981 A1
(43) Pub. Date: Oct. 1, 2026

(54) CONTROL DEVICE AND DRIVE CONTROL METHOD

(71) Applicant: Mitsubishi Electric Corporation, Tokyo (JP)

(72) Inventors: Toshiki SUZUKI, Tokyo (JP); Aoto YAMAMOTO, Tokyo (JP)

(73) Assignee: Mitsubishi Electric Corporation, Tokyo (JP)

(21) Appl. No.: 18/881,315

(22) PCT Filed: Jul. 13, 2022
(86) PCT No.: PCT/JP2022/027610

§ 371 Date: Jan. 6, 2025

(51) Int. Cl. H02P 21/18; H02P 21/22

(52) U.S. Cl. CPC H02P 21/18; H02P 21/22

(57) ABSTRACT

A control device performing drive control of a multiphase rotary machine includes: a current detector detecting a rotary machine current; a controller generating a drive voltage command for driving the rotary machine based on the rotary machine current and an estimated rotor position; a voltage applicator applying a voltage to the rotary machine based on the drive voltage command; and a position estimator estimating the rotor position based on the rotary machine current. The position estimator determines a type of a voltage vector output from the voltage applicator based on a gate signal of the voltage applicator, calculates a change amount of the rotator current for each type of voltage vector, generates an AC signal having zero DC component and changing at a double angle of the rotor position based on a rotary machine current change amount, and estimates the rotor position based on the AC signal.

### FIELD

The present disclosure relates to a control device and a drive control method for performing drive control of a rotary machine.

### BACKGROUND

For driving a rotary machine, position information of the rotor is required. A position sensor can be used to detect the rotor position, but the use of the position sensor causes problems such as an increase in size, an increase in cost, and a decrease in environmental resistance of the system.

As a countermeasure, Patent Literature 1 discloses a method for estimating the rotor position without using a position sensor. With the method disclosed in Patent Literature 1, the rotor position is estimated using the fact that the change amount of the rotary machine current during application of an effective voltage vector changes at a double angle of the rotor position.

### CITATION LIST

### Patent Literature

Patent Literature 1: Japanese Patent Application Laid-open No. 2018-153027

### SUMMARY OF INVENTION

### Problem to be Solved by the Invention

However, the above-described conventional technique is problematic in that a position estimation error may increase in an appearance pattern of effective voltage vectors in which differential information of the rotary machine current becomes a fragmentary signal. For example, in a case where current vector control is performed using three-phase common triangular wave carrier pulse width modulation (PWM), there is a correlation between the type of the effective voltage vector appearing by current vector control and the rotor position, and when the rotary machine is driven at a low speed, a specific type of effective voltage vector appears for a long time. In a case where the change amount of the rotary machine current with respect to the effective voltage vector is acquired under such conditions, the change amount of the rotary machine current becomes a fragmentary signal.

The present disclosure has been made in view of the above, and an object thereof is to provide a control device capable of estimating the rotor position with high accuracy even under a condition that the change amount of the rotary machine current with respect to the effective voltage vector is fragmentary.

### Means to Solve the Problem

In order to solve the above-described problems and achieve the object, a control device according to the present disclosure is a control device that performs drive control of a multiphase rotary machine. The control device includes: a current detection unit to detect a rotary machine current flowing through the rotary machine; a drive voltage command calculation unit to generate a drive voltage command for driving the rotary machine based on the rotary machine current and an estimated value of a rotor position of the rotary machine; a voltage applicator to apply a voltage to the rotary machine based on the drive voltage command generated; and a position estimation unit to estimate the rotor position based on the rotary machine current. The position estimation unit determines a type of a voltage vector output from the voltage applicator based on a gate signal of the voltage applicator, calculates a change amount of the rotator current for each type of the voltage vector determined, generates an AC signal having a DC component of zero and changing at a double angle of the rotor position based on a rotary machine current change amount that is a calculation result, and estimates the rotor position based on the AC signal.

### Effects of the Invention

The present disclosure can achieve the effect of obtaining a control device capable of estimating the rotor position with high accuracy even under a condition that the change amount of the rotary machine current with respect to the effective voltage vector is fragmentary.

### BRIEF DESCRIPTION OF DRAWINGS

FIG. 1 is a diagram illustrating an exemplary configuration of a control device for a rotary machine according to the first embodiment.

FIG. 2 is a diagram illustrating an exemplary circuit configuration of the voltage applicator illustrated in FIG. 1.

FIG. 3 is a diagram illustrating an example of a correspondence relationship between the switching states of each phase of the voltage applicator illustrated in FIG. 1 and the definitions of voltage vectors.

FIG. 4 is a diagram illustrating the eight switching states and voltage vectors illustrated in FIG. 3.

FIG. 5 is a diagram for explaining signal processing in the position estimator illustrated in FIG. 1.

FIG. 6 is a diagram illustrating a detailed configuration of the current differential information calculation unit illustrated in FIG. 5.

FIG. 7 is a diagram illustrating DC components and AC components included in current differential information.

FIG. 8 is a diagram illustrating output of the current differential information calculation unit illustrated in FIG. 5.

FIG. 9 is a diagram for explaining classification performed by the classifier.

FIG. 10 is an explanatory diagram regarding the operation of the classifier illustrated in FIG. 5.

FIG. 11 is a block diagram illustrating a configuration of the phase synchronization calculation unit illustrated in FIG. 5.

FIG. 12 is a diagram illustrating output of each unit of the position estimator illustrated in FIG. 5.

FIG. 13 is a diagram illustrating a first example of a hardware configuration for implementing the functions of the control device according to the first embodiment and the second embodiment.

FIG. 14 is a diagram illustrating a second example of a hardware configuration for implementing the functions of the control device according to the first embodiment and the second embodiment.

### DESCRIPTION OF EMBODIMENTS

Hereinafter, a control device and a drive control method according to embodiments of the present disclosure will be described in detail with reference to the drawings.

### First Embodiment

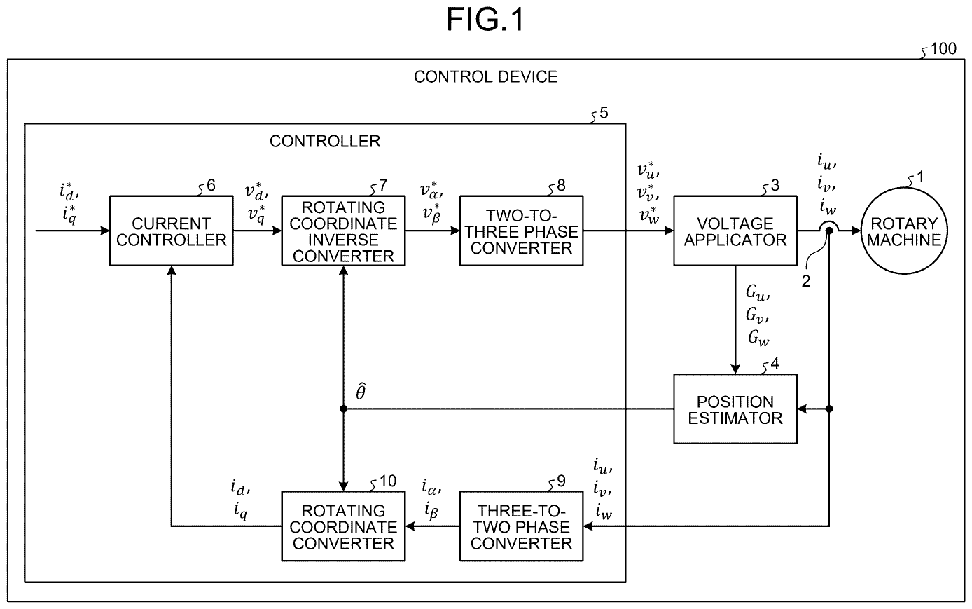

FIG. 1 is a diagram illustrating an exemplary configuration of a control device for a rotary machine according to the first embodiment. Hereinafter, a “control device for a rotary machine” may be simply referred to as a “control device”. The control device 100 illustrated in FIG. 1 includes a rotary machine 1, a current detector 2, a voltage applicator 3, a position estimator 4, and a controller 5. The controller 5 includes a current controller 6, a rotating coordinate inverse converter 7, a two-to-three phase converter 8, a three-to-two phase converter 9, and a rotating coordinate converter 10.

The rotary machine 1 is a three-phase synchronous reluctance motor (SynRM) that generates torque using saliency of the rotor. The voltage applicator 3 is connected to the rotary machine 1. The current detector 2 is provided between the rotary machine 1 and the voltage applicator 3.

The current detector 2 detects alternating currents supplied from the voltage applicator 3 to the rotary machine 1, and outputs the detected values of the alternating currents as rotary machine currents iᵤ, iᵥ, and i_{w}. The rotary machine currents iᵤ, iᵥ, and i_{w} are supplied to the rotary machine 1, and the values of rotary machine currents iᵤ, iᵥ, and i_{w} are output to each of the position estimator 4 and the controller 5.

The voltage applicator 3 supplies AC power to the rotary machine 1 according to rotary machine voltage commands vᵤ*, vᵥ*, and v_{w}* supplied from the controller 5.

The position estimator 4 calculates an estimated rotor position using the rotary machine currents iᵤ, iᵥ, and i_{w} detected by the current detector 2 and gate signals (to be described later) of the voltage applicator 3. In the following description, the rotor position is represented by “θ”, and an estimated value of the rotor position θ is represented by “θ” with “\hat{ }” on it. Note that a sign consisting of “θ” with “\hat{ }” on it may be represented by “θ” with “\hat{ }” after it. Similarly, a sign consisting of a symbol representing a certain parameter with “\hat{ }” on or after it represents an estimated value of the parameter. The position estimator 4 outputs the estimated rotor position θ\hat{ } to the controller 5.

The controller 5 calculates the rotary machine voltage commands vᵤ*, vᵥ*, and v_{w}* for driving the rotary machine 1 such that rotary machine currents i_{d} and i_{q} in the rotating coordinate system of the rotary machine 1 have values indicated by rotary machine current commands i_{d}* and i_{q}* in the rotating coordinate system, and outputs the calculated rotary machine voltage commands vᵤ*, vᵥ*, and v_{w}* to the voltage applicator 3.

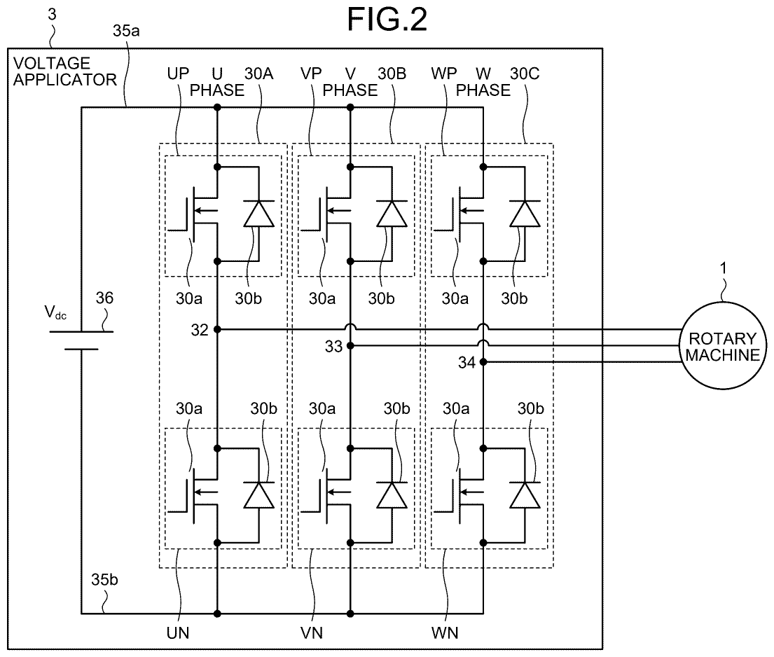

FIG. 2 is a diagram illustrating an exemplary circuit configuration of the voltage applicator 3 illustrated in FIG. 1. FIG. 2 illustrates an exemplary circuit configuration in a case where the voltage applicator 3 is a three-phase PWM inverter. The voltage applicator 3 includes a leg 30A in which a semiconductor element UP of the upper arm and a semiconductor element UN of the lower arm are connected in series, a leg 30B in which a semiconductor element VP of the upper arm and a semiconductor element VN of the lower arm are connected in series, and a leg 30C in which a semiconductor element WP of the upper arm and a semiconductor element WN of the lower arm are connected in series. The leg 30A, the leg 30B, and the leg 30C are connected in parallel to each other.

A bus voltage is applied to the voltage applicator 3 through DC buses 35a and 35b. The voltage applicator 3 converts DC power of a power source 36 supplied through the DC buses 35a and 35b into AC power, and supplies the resultant AC power to the rotary machine 1 to drive the rotary machine 1. In FIG. 2, the current detector 2 is omitted.

FIG. 2 illustrates a case where the semiconductor elements UP, UN, VP, VN, WP, and WN are metal-oxide-semiconductor field-effect transistors (MOSFET). Each of the semiconductor elements UP, UN, VP, VN, WP, and WN includes a transistor 30a and a diode 30b connected in anti-parallel to the transistor 30a. The phrase “connected in anti-parallel” means that the anode side of the diode is connected to the first terminal corresponding to the source of the MOSFET and the cathode side of the diode is connected to the second terminal corresponding to the drain of the MOSFET.

Instead of MOSFETs, insulated gate bipolar transistors (IGBTs) may be used as the semiconductor elements UP, UN, VP, VN, WP, and WN.

A connection point 32 between the semiconductor element UP of the upper arm and the semiconductor element UN of the lower arm is connected to the first phase, for example, the u-phase, of the rotary machine 1. A connection point 33 between the semiconductor element VP of the upper arm and the semiconductor element VN of the lower arm is connected to the second phase, for example, the v phase, of the rotary machine 1. A connection point 34 between the semiconductor element WP of the upper arm and the semiconductor element WN of the lower arm is connected to the third phase, for example, the w phase, of the rotary machine 1. In the voltage applicator 3, the connection points 32, 33, and 34 constitute the AC terminal.

Here, the voltage vector output from the voltage applicator 3 will be described. The voltage applicator 3 is a three-phase PWM inverter as described above, and is a power converter that obtains a desired voltage by performing PWM control on the power source 36 supplied through the DC buses 35a and 35b. The three-phase PWM inverter includes two switching elements (upper and lower) per phase, and the upper and lower switching elements operate such that one of the switching elements is on. Therefore, a three-phase triangular wave comparison inverter has 2³, that is, eight switching states. Here, the states of the gate signals of the upper arms of the u phase, the v phase, and the w phase in the voltage applicator 3 are defined as Gᵤ, Gᵥ, and G_{w}, respectively. When the values of Gᵤ, G_{y}, and G_{w} are one, it means that the semiconductor element of the upper arm of the corresponding phase is in a conductive state, and when the values of Gᵤ, Gᵥ, and G_{w} are zero, it means that the semiconductor element of the lower arm of the corresponding phase is in a conductive state. For example, under the condition of (Gᵤ, Gᵥ, G_{w})=(1, 0, 0), it means a state in which the semiconductor element of the upper arm of the u phase is conductive and the semiconductor elements of the lower arms of the v phase and the w phase are conductive.

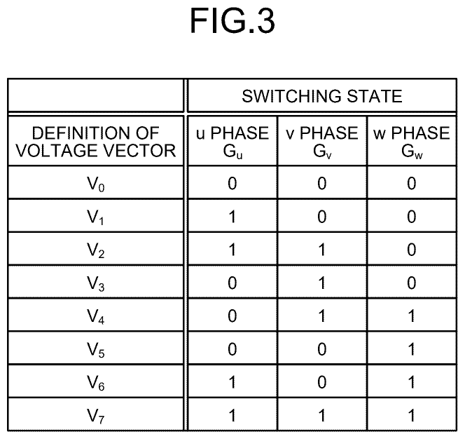

Here, voltage vectors in the eight switching states of the voltage applicator 3 are defined as V₀ to V₇. FIG. 3 is a diagram illustrating an example of a correspondence relationship between the switching states of each phase of the voltage applicator 3 illustrated in FIG. 1 and the definitions of voltage vectors. The applied voltage vector is defined as V₀ under the condition of (Gᵤ, Gᵥ, G_{w})=(0, 0, 0), the applied voltage vector is defined as V₁ under the condition of (Gᵤ, Gᵥ, G_{w})=(1, 0, 0), the applied voltage vector is defined as V₂ under the condition of (Gᵤ, Gᵥ, G_{w})=(1, 1, 0), and the applied voltage vector is defined as V₃ under the condition of (Gᵤ, Gᵥ, G_{w})=(0, 1, 0). In addition, the applied voltage vector is defined as V₄ under the condition of (Gᵤ, Gᵥ, G_{w})=(0, 1, 1), the applied voltage vector is defined as V₅ under the condition of (Gᵤ, G_{y}, G_{w})=(0, 0, 1), the applied voltage vector is defined as V₆ under the condition of (Gᵤ, Gᵥ, G_{w})=(1, 0, 1), and the applied voltage vector is defined as V₇ under the condition of (Gᵤ, G_{y}, G_{w})=(1, 1, 1). Among the eight voltage vectors V₀ to V₇, the voltage vectors V₀ and V₇ are referred to as zero voltage vectors, and the other voltage vectors, namely, the voltage vectors V₁ to V₆, are referred to as effective voltage vectors. The voltage vectors V₀ to V₇ may be referred to as the voltage vectors V₀₋₇ (alternatively, V_{0 to 7}). Similarly, the effective voltage vectors V₁ to V₆ may be referred to as the effective voltage vectors V₁₋₆ (alternatively, V_{1 to 6}).

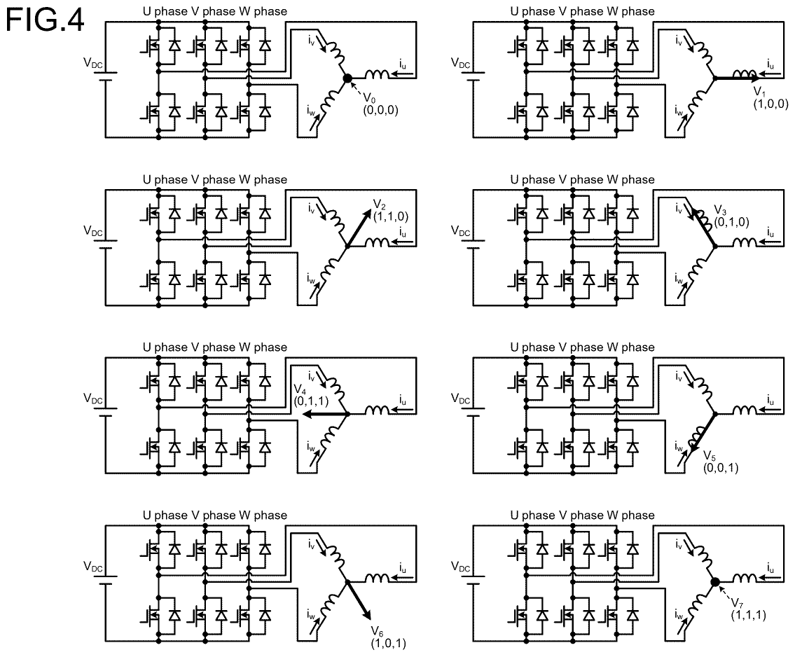

FIG. 4 is a diagram illustrating the eight switching states and voltage vectors illustrated in FIG. 3. FIG. 4 illustrates the voltage vector in each switching state and the conduction state of each semiconductor element of the voltage applicator 3.

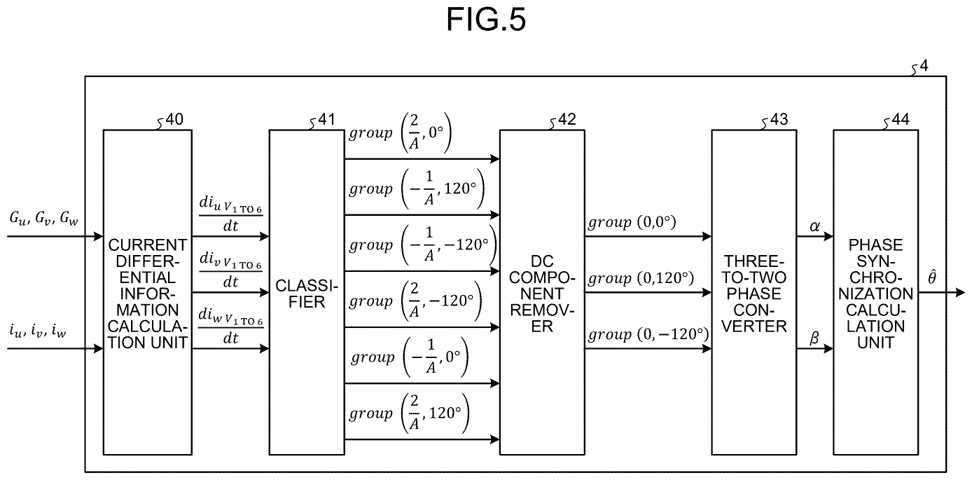

FIG. 5 is a diagram for explaining signal processing in the position estimator 4 illustrated in FIG. 1. The position estimator 4 calculates an estimated rotor position θ\hat{ } which is an estimated value of the position of the rotor of the rotary machine 1 using the rotary machine currents iᵤ, iᵥ, and i_{w} detected by the current detector 2 and the gate signals Gᵤ, Gᵥ, and G_{w} of the voltage applicator 3. Specifically, the position estimator 4 includes a current differential information calculation unit 40, a classifier 41, a DC component remover 42, a three-to-two phase converter 43, and a phase synchronization calculation unit 44.

The current differential information calculation unit 40 calculates current differential information corresponding to each of the effective voltage vectors V₁ to V₆. The current differential information calculation unit 40 calculates current differential information corresponding to the effective voltage vectors V₁ to V₆ for the u-phase, v-phase, and w-phase rotary machine currents iᵤ, iᵥ, and i_{w}. Therefore, the current differential information output from the current differential information calculation unit 40 is 3×6=18 types. The current differential information is also referred to as a rotary machine current change amount. The gate signals Gᵤ, Gᵥ, and G_{w} of the semiconductor element of the upper arm of each phase of the voltage applicator 3 and the rotary machine currents iᵤ, iᵥ, and i_{w} are input to the current differential information calculation unit 40.

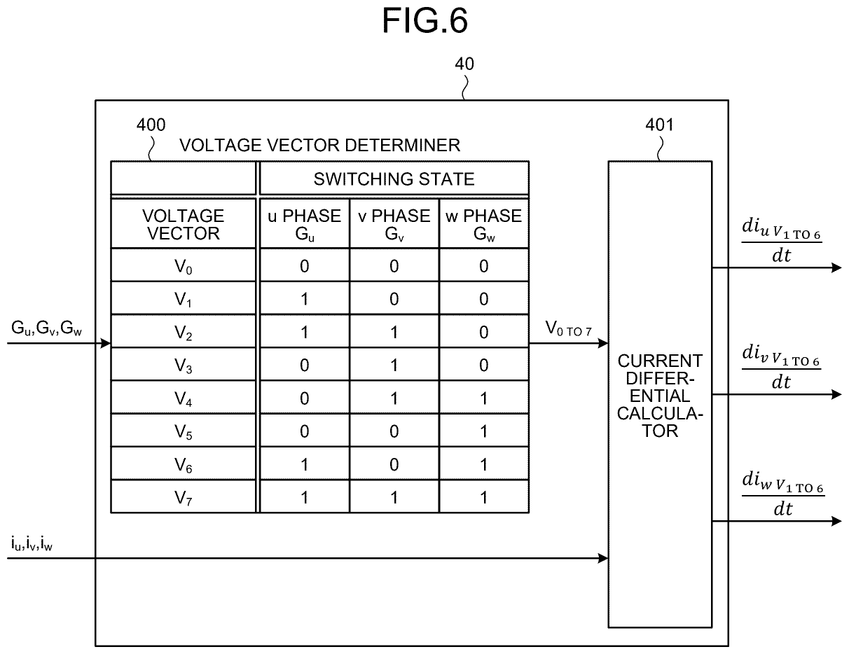

FIG. 6 is a diagram illustrating a detailed configuration of the current differential information calculation unit 40 illustrated in FIG. 5. The current differential information calculation unit 40 includes a voltage vector determiner 400 that determines the type of the voltage vector output from the voltage applicator 3, and a current differential calculator 401 that calculates current differential information of each phase corresponding to the effective voltage vector using the determination result of the voltage vector determiner 400 and the rotary machine currents iᵤ, iᵥ, and i_{w}.

The voltage vector determiner 400 determines the type of the voltage vector output from the voltage applicator 3 from the gate signals Gᵤ, G_{y}, and G_{w} of the semiconductor elements of the upper arm of each phase of the voltage applicator 3 based on the definitions illustrated in FIG. 3. The voltage vector determiner 400 determines which of the voltage vectors V₀₋₇ the type of the voltage vector is, from the values of the gate signals Gᵤ, Gᵥ, and G_{w}, and outputs the voltage vector V₀₋₇ that is the determination result to the current differential calculator 401.

The current differential calculator 401 calculates current differential information of each phase corresponding to each of the effective voltage vectors V₁₋₆ based on the voltage vector V₀₋₇ which is the determination result of the voltage vector determiner 400 and the rotary machine currents iᵤ, iᵥ, and i_{w}. The current differential calculator 401 stores the type of the current voltage vector V₀₋₇ and the type of the voltage vector one control cycle before, and if the same effective voltage vector appears over two or more control cycles, calculates current differential information of each phase corresponding to the type of the effective voltage vector. The control cycle is set to a sufficiently short value with respect to the cycle of the triangular wave carrier of the voltage applicator 3 in order to sample two or more points of the current during application of the effective voltage vector. If the type of the current voltage vector is V_{N} and the type of the voltage vector one control cycle before is V_{N}, the current differential calculator 401 calculates the current differential information of the u phase, the v phase, and the w phase at the time of applying the voltage vector V_{N} as “di_{uvN}/dt”, “di_{vVN}/dt”, and “di_{wVN}/dt”, respectively. Here, N is an integer from one to six. The current differential calculator 401 distinctively calculates the six types of effective voltage vectors V₁₋₆ and the three phases of current differential information, thereby outputting 18 types of current differential information “diᵤᵥ₁₋₆/dt”, “di_{vV1-6}/dt”, and “di_{wvl-6}/dt”.

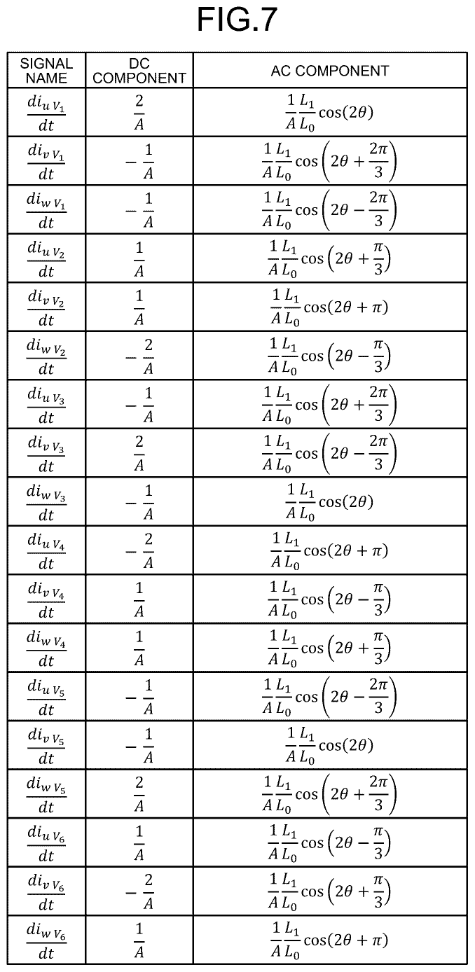

Here, a total of 18 types of current differential information output from the current differential calculator 401 will be described. Current differential information includes a DC component and an AC component. FIG. 7 is a diagram illustrating DC components and AC components included in current differential information. In FIG. 7, a signal name, a formula indicating a DC component, and a formula indicating an AC component are associated with each of the 18 types of current differential information. In the “signal name”, u, v, and w indicate corresponding phases of the rotary machine 1, and V₁ to V₆ indicate corresponding types of effective voltage vectors.

Features of the “DC component” of the current differential information illustrated in FIG. 7 will be described. Here, defining A with Formula (1) below, the “DC component” of the current differential information is generated with a magnitude of “2/A” in a phase in the direction of the effective voltage vector, and is generated with a magnitude of “1/A” with a reverse sign in a phase other than the phase in the direction of the effective voltage vector. Therefore, the sum of the u-phase DC component, the v-phase DC component, and the w-phase DC component during application of the same effective voltage vector is zero. Here, V_{dc} is the DC voltage of the power source 36 of the voltage applicator 3.

$$\begin{matrix}Formula 1 & \\ A = \frac{3 {L}_{0} ( 1 - {( \frac{{L}_{1}}{2 {L}_{0}} )}^{2} )}{{V}_{d c}} & ( 1 )\end{matrix}$$

L₀ in Formula (1) is expressed by Formula (2) below. In addition, L₁ in Formula (1) is expressed by Formula (3) below. Here, L_{d} is the d-axis inductance of the rotary machine 1, and L_{q} is the q-axis inductance of the rotary machine 1.

$$\begin{matrix}Formula 2 & \\ {L}_{0} = \frac{{L}_{d} + {L}_{q}}{2} & ( 2 )\end{matrix}$$

$$\begin{matrix}Formula 3 & \\ {L}_{1} = \frac{- {L}_{d} + {L}_{q}}{2} & ( 3 )\end{matrix}$$

Next, features of the “AC component” of the current differential information will be described. Here, given that the number of the effective voltage vector is N, the AC component of the u-phase current differential information is expressed by Formula (4), the AC component of the v-phase current differential information is expressed by Formula (5), and the AC component of the w-phase current differential information is expressed by Formula (6).

$$\begin{matrix}Formula 4 & \\ \frac{d {i}_{u {V}_{N} A C}}{d t} = \frac{1}{A} \frac{{L}_{1}}{{L}_{0}} cos ( 2 ( θ + \frac{π}{6} ( N - 1 ) ) ) & ( 4 )\end{matrix}$$

$$\begin{matrix}Formula 5 & \\ \frac{d {i}_{v {V}_{N} A C}}{d t} = \frac{1}{A} \frac{{L}_{1}}{{L}_{0}} cos ( 2 ( θ - \frac{2 π}{3} + \frac{π}{6} ( N - 1 ) ) ) & ( 5 )\end{matrix}$$

$$\begin{matrix}Formula 6 & \\ \frac{d {i}_{w {V}_{N} A C}}{d t} = \frac{1}{A} \frac{{L}_{1}}{{L}_{0}} cos ( 2 ( θ + \frac{2 π}{3} + \frac{π}{6} ( N - 1 ) ) ) & ( 6 )\end{matrix}$$

As shown in Formulas (4) to (6), the current differential information obtained by applying the effective voltage vector has information of the rotor position θ. In the column of “AC component” in FIG. 7, expanded forms are shown for the phases in Formulas (4) to (6). As is clear from FIG. 7 and Formulas (4) to (6), the AC components of the current differential information during the application period of the same effective voltage vector are characterized in having a phase difference of “±2π/3” from each other, and having the respective reference phases shifted depending on the application direction of the effective voltage vector. The magnitude of the amplitude of the AC component is equal for all combinations of effective voltage vectors and phases, and is “(1/A)×(L₁/L₀)”. Note that, since the magnitude relationship between the d-axis and q-axis inductances is different between interior permanent magnet synchronous motors (IPMSM) and synchronous reluctance motors, the value of the coefficient “(1/A)×(L₁/L₀)” of the cosine function is a positive value in interior permanent magnet synchronous motors, and is a negative value in synchronous reluctance motors.

In each phase, current differential information obtained by a combination of effective voltage vectors having a relationship of magnetization and demagnetization directions has a relationship of reverse signs as expressed by Formulas (7) to (9) below. In Formulas (7) to (9), n is an integer from one to three. A combination of voltage vectors having a relationship of magnetization and demagnetization directions is V1 and V4 in the u phase, V3 and V6 in the v phase, and V5 and V2 in the w phase.

$$\begin{matrix}Formula 7 & \\ \frac{d {i}_{u {V}_{n}}}{d t} = - \frac{d {i}_{u {V}_{n + 3}}}{d t} & ( 7 )\end{matrix}$$

$$\begin{matrix}Formula 8 & \\ \frac{d {i}_{v {V}_{n}}}{d t} = - \frac{d {i}_{v {V}_{n + 3}}}{d t} … & ( 8 )\end{matrix}$$

$$\begin{matrix}Formula 9 & \\ \frac{d {i}_{w {V}_{n}}}{d t} = - \frac{d {i}_{w {V}_{n + 3}}}{d t} … & ( 9 )\end{matrix}$$

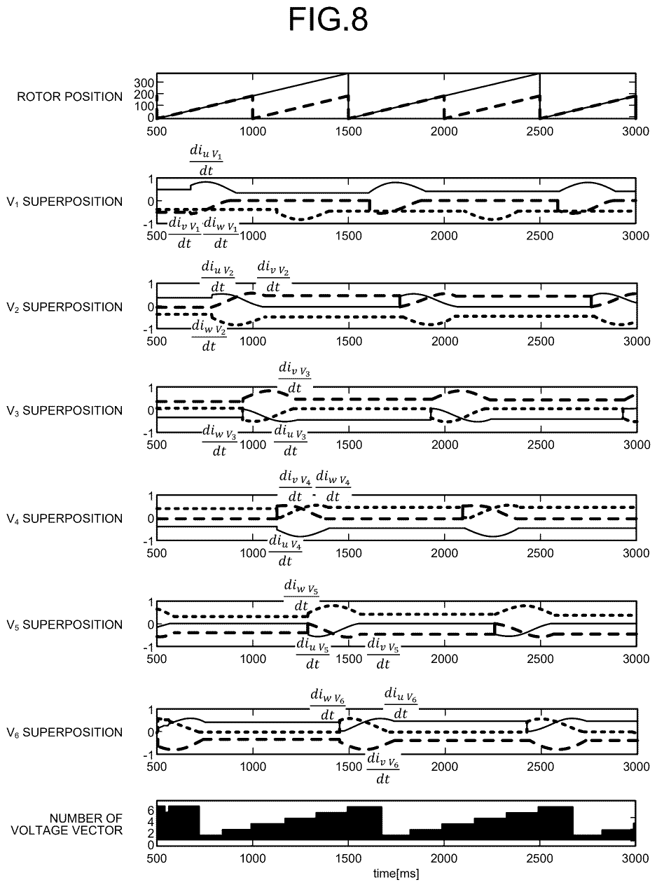

FIG. 8 is a diagram illustrating output of the current differential information calculation unit 40 illustrated in FIG. 5. FIG. 8 shows a simulation result of current vector control on a synchronous reluctance motor rotating at a low speed, in which the PWM of the voltage applicator 3 is based on three-phase common triangular wave carrier comparison that is generally used. The voltage vectors of V0 and V7 are numbered zero for the sake of explanation. Here, focusing on the rotor position and the number of the applied voltage vector, a correlation can be confirmed between the rotor position and the appearance pattern of voltage vectors. In a period in which a specific effective voltage vector appears, current differential information corresponding to other effective voltage vectors cannot be acquired. Therefore, in an appearance pattern of effective voltage vectors in which a specific effective voltage vector occurs for a long time, the current differential information is fragmentary. Further, each piece of current differential information has a characteristic that timings at which the current differential information can be acquired are different, and the delay amount is different depending on the signal. From this characteristic, signal processing that is performed without considering the appearance pattern of voltage vectors results in unstable position sensorless control. Here, “signal processing that is performed without considering the appearance pattern of voltage vectors” corresponds to, for example, a case where the type of current differential information used for estimating the rotor position is fixed regardless of the type of the appearing voltage vector.

Therefore, the position estimator 4 performs signal processing of generating an AC component of continuous current differential information having rotor position information from fragmentary current differential information. Hereinafter, a signal processing method that is implemented by the position estimator 4 will be described. The current differential information has the features indicated by Formulas (4) to (9) above. Utilizing these features, the same waveform shape appears in the current differential information under conditions of different voltage vectors and phases. Therefore, the position estimator 4 interpolates fragmentary current differential information using the waveform shape appearing under conditions of different voltage vectors and phases, and generates an AC component of continuous current differential information.

Returning to FIG. 5, the classifier 41 classifies the current differential information output from the current differential information calculation unit 40 into any one of six types of signals based on the magnitude of the DC component and the reference phase. Based on the features of Formulas (4) to (9) above, the classifier 41 makes classifications into six types: group (2/A, 0°), group (−1/A, 120°), group (−1/A, −120°), group (2/A, −120°), group (−1/A, 0°), and group (2/A, 120°), according to the magnitude of the DC component and the phase of the AC component.

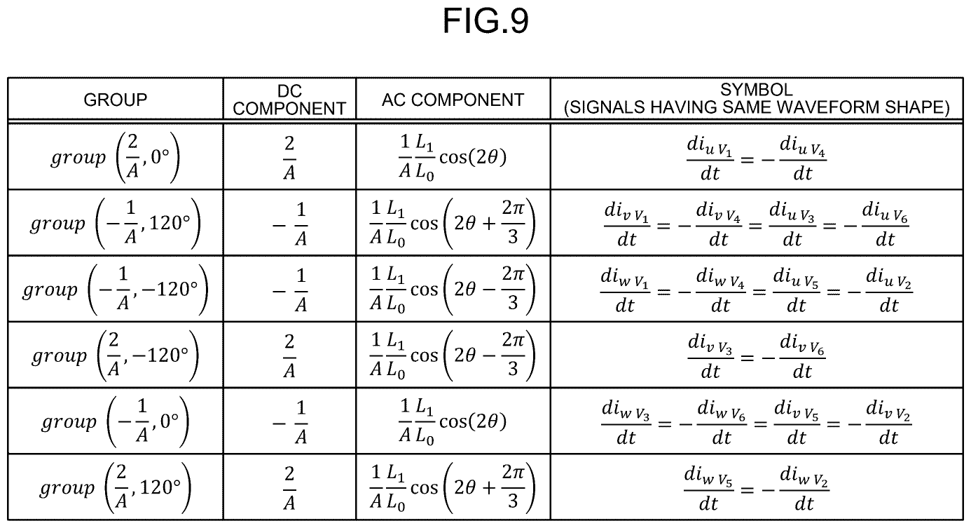

FIG. 9 is a diagram for explaining classification performed by the classifier 41. FIG. 9 illustrates “group”, “DC component”, “AC component”, and “symbol” for each of the six groups classified by the classifier 41. Here, “group” indicates the name of a group, and the group described as group (X, Y°) means a group in which the DC component is X and the reference phase of the AC component is Y°. For example, the reference phase Y in the cosine component “cos (2θ+2π/3)” of the AC component in FIG. 9 is 2π/3[rad]=120[°]. “Symbol” indicates signals having the same waveform shape. For example, in the group of group (2/A, 0°), it means that the waveform of the u-phase current differential information at the time when the effective voltage vector V1 is applied and the waveform of the u-phase current differential information at the time when the effective voltage vector V4 is applied are the same.

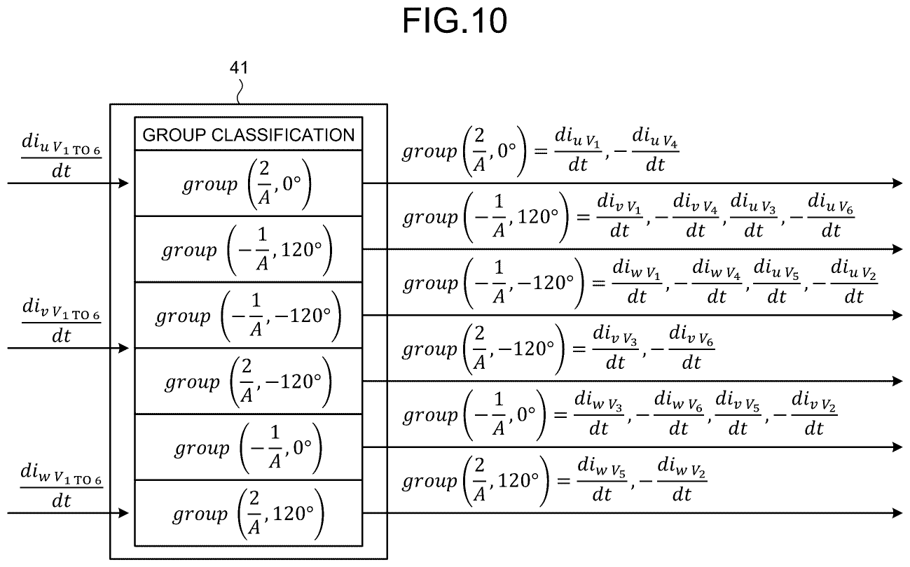

FIG. 10 is an explanatory diagram regarding the operation of the classifier 41 illustrated in FIG. 5. When the current differential information “di_{uV1-6}/dt”, “di_{vV1-6}/dt”, and “di_{wV1-6}/dt” is input, the classifier 41 generates six types of signals based on the classification illustrated in FIG. 9. Specifically, the classifier 41 operates to prepare variables corresponding to the six types of groups, substitute current differential information for the variables of the groups into which the current differential information input to the classifier 41 is classified, and hold the previous values for the variables of the other groups. Here, the name of the group is used as a variable name for description. Group (X, Y°) is a variable of a group in which the DC component is X and the reference phase of the AC component is Y°. For example, as for group (2/A, 0°), the classifier 41 substitutes “di_{uV1}/dt” under the condition that V₁ is applied, substitutes “−di_{uV4}/dt” under the condition that V4 is applied, and operates to hold the previous value under the condition that the effective voltage vectors other than V1 and V4, that is, V2, V3, V5, and V6, are applied. Similarly, as for group (−1/A, 120°), the classifier 41 operates to substitute “di_{vV1}/dt” under the condition that V1 is applied, substitute “−di_{vV4}/dt” under the condition that V4 is applied, substitute “di_{vV3}/dt” under the condition that V3 is applied, substitute “−di_{vV6}/dt” under the condition that V6 is applied, and hold the previous value under the condition that V2 and V5 are applied.

Returning to FIG. 5, the DC component remover 42 extracts a DC component from the output of the classifier 41, and subtracts the DC component from current differential information obtained by applying the latest effective voltage vector, thereby generating a continuous AC component. In the first embodiment, an example of extracting a DC component using the three-phase equilibrium condition will be described. In order to extract the DC component “1/A” using the three-phase equilibrium condition, Formulas (10) to (14) below are used. That is, the DC component remover 42 calculates the sum of the signals of the combinations having phases of 0°, 120°, and −120° from the output of the classifier 41, and multiplies the sum by the coefficient of conversion to the DC component to calculate the DC component. Here, the five types of Formulas (10) to (14) are shown, but the DC component remover 42 only needs to perform computation by using at least one appropriate formula by a combination of the latest effective voltage vector and the nearest effective voltage vector having a different number from the latest effective voltage vector.

$$\begin{matrix}Formula 10 & \\ \frac{1}{A} = \frac{1}{6} \{ group ( \frac{2}{A} , 0 ° ) + group ( \frac{2}{A} , 120 ° ) + group ( \frac{2}{A} , - 120 ° ) \} & ( 10 )\end{matrix}$$

$$\begin{matrix}Formula 11 & \\ \frac{1}{A} = \frac{1}{3} \{ group ( - \frac{1}{A} , 0 ° ) + group ( - \frac{1}{A} , 120 ° ) + group ( - \frac{1}{A} , - 120 ° ) \} & ( 11 )\end{matrix}$$

$$\begin{matrix}Formula 12 & \\ \frac{1}{A} = \frac{1}{3} \{ group ( \frac{2}{A} , 0 ° ) + group ( \frac{2}{A} , 120 ° ) + group ( - \frac{2}{A} , - 120 ° ) \} & ( 12 )\end{matrix}$$

$$\begin{matrix}Formula 13 & \\ \frac{1}{A} = \frac{1}{3} \{ group ( \frac{2}{A} , 0 ° ) + group ( - \frac{1}{A} , 120 ° ) + group ( \frac{2}{A} , - 120 ° ) \} & ( 13 )\end{matrix}$$

$$\begin{matrix}Formula 14 & \\ \frac{1}{A} = \frac{1}{3} \{ group ( - \frac{1}{A} , 0 ° ) + group ( \frac{2}{A} , 120 ° ) + group ( \frac{2}{A} , - 120 ° ) \} & ( 14 )\end{matrix}$$

Specifically, the DC component remover 42 uses a formula that uses the latest effective voltage vector and the nearest effective voltage vector having a different number from the latest effective voltage vector among Formulas (10) to (14). Here, for example, group (2/A, 0°) is generated based on current differential information at the time when the effective voltage vector V1 or V4 is applied, group (2/A, 120°) is generated based on current differential information at the time when the effective voltage vector V5 or V2 is applied, and group (2/A, −120°) is generated based on current differential information at the time when the effective voltage vector V3 or V6 is applied. Therefore, Formula (10) can be said to be a formula that uses the effective voltage vectors V1 or V4, V5 or V2, and V3 or V6. Similarly, Formula (11) is a formula that uses the effective voltage vectors V2 or V5, and V₁ or V3 or V4 or V6. Formula (12) is a formula that uses the effective voltage vectors V1 or V4 and V2 or V5. Formula (13) is a formula that uses the effective voltage vectors V1 or V4 and V3 or V6. Formula (14) is a formula that uses the effective voltage vectors V2 or V5 and V3 or V6.

For example, when the combination of the latest effective voltage vector and the nearest effective voltage vector having a different number from the latest effective voltage vector is V1 and V2, at least one formula that uses these voltage vectors is selected from Formulas (10) to (14). Formulas that use the effective voltage vectors V1 and V2 are Formula (11) and Formula (12). Therefore, the DC component remover 42 calculates the DC component “1/A” using at least one of Formulas (11) or (12). When a plurality of formulas are used, the DC component remover 42 can calculate the DC component “1/A” by using an average value of calculation results of the plurality of formulas.

Subsequently, the DC component remover 42 uses the extracted DC component to subtract the DC component from the current differential information obtained by applying the latest effective voltage vector, thereby calculating the AC component of the latest current differential information. The DC component remover 42 can calculate the AC component of the latest current differential information using Formulas (15) to (17) below. The DC component remover 42 selects a formula based on the type of the latest voltage vector among Formulas (15) to (17)

$$\begin{matrix}Formula 15 & \\ & ( 15 )\end{matrix}$$

$$group ( 0 , 0 ° ) = \{ \begin{matrix}group ( \frac{2}{A} , 0 ° ) - \frac{2}{A} & ( Update with V 1 and V 4 ) \\ group ( - \frac{1}{A} , 0 ° ) + \frac{1}{A} & ( Update with V 2 , V 3 , V 5 , and V 6 )\end{matrix}$$

$$\begin{matrix}Formula 16 & \\ & ( 16 )\end{matrix}$$

$$group ( 0 , 120 ° ) = \{ \begin{matrix}group ( \frac{2}{A} , 120 ° ) - \frac{2}{A} & ( Update with V 2 and V 5 ) \\ group ( - \frac{1}{A} , 120 ° ) + \frac{1}{A} & ( Update with V 1 , V 3 , V 4 , and V 6 )\end{matrix}$$

$$\begin{matrix}Formula 17 & \\ & ( 17 )\end{matrix}$$

$$group ( 0 , - 120 ° ) = \{ \begin{matrix}group ( \frac{2}{A} , - 120 ° ) - \frac{2}{A} & ( Update with V 3 and V 6 ) \\ group ( - \frac{1}{A} , - 120 ° ) + \frac{1}{A} & ( Update with V 1 , V 2 , V 4 , and V 5 )\end{matrix}$$

The DC component remover 42 outputs the calculation results, namely group (0, 0°), group (0, 120°), and group (0, −120°), to the three-to-two phase converter 43. The outputs group (0, 0°), group (0, 120°), and group (0, −120°) of the DC component remover 42 are continuous AC components including rotor position information. Hereinafter, a method of calculating the rotor position using the AC components will be described. As methods of calculating the rotor position from AC components having a phase difference of ±2n/3 from each other, for example, there are a method of performing three-phase to two-phase conversion on these AC components and performing an arc tangent calculation, a method of performing phase synchronization calculation on a three-phase to two-phase conversion result and estimating the rotor position, and the like. Here, a method of estimating the rotor position through phase synchronization calculation will be described as an example.

The three-to-two phase converter 43 calculates an α-axis AC component α and a β-axis AC component β which are orthogonal biaxial AC components. The three-to-two phase converter 43 calculates the α-axis AC component α and the β-axis AC component β using Formula (18) below, and outputs the calculated α-axis AC component α and β-axis AC component β to the phase synchronization calculation unit 44.

$$\begin{matrix}Formula 18 & \\ [ \begin{matrix}α \\ β\end{matrix} ] = \sqrt{\frac{2}{3}} [ \begin{matrix}1 & - \frac{1}{2} & - \frac{1}{2} \\ 0 & - \frac{\sqrt{3}}{2} & \frac{\sqrt{3}}{2}\end{matrix} ] [ \begin{matrix}group ( 0 , 0 ° ) \\ group ( 0 , 120 ° ) \\ group ( 0 , - 120 ° )\end{matrix} ] & ( 18 )\end{matrix}$$

The phase synchronization calculation unit 44 estimates the rotor position of the rotary machine 1 based on the α-axis AC component α and the β-axis AC component β output from the three-to-two phase converter 43.

Specifically, the phase synchronization calculation unit 44 estimates the rotor position of the rotary machine 1 by performing phase synchronization calculation on the α-axis AC component α and the β-axis AC component β.

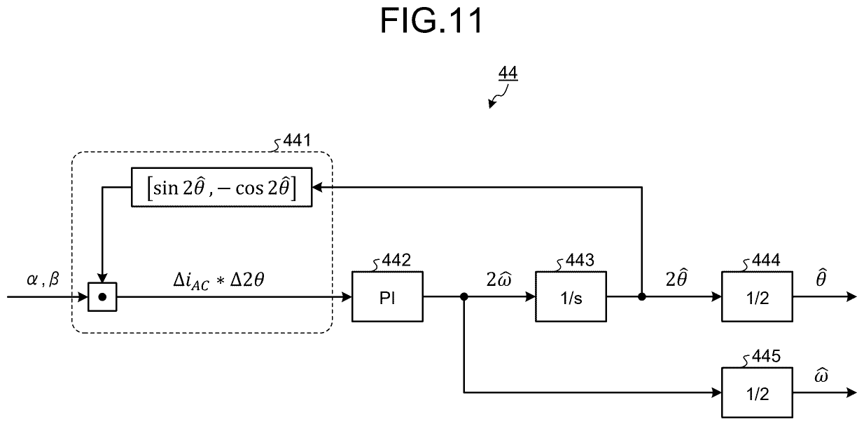

FIG. 11 is a block diagram illustrating a configuration of the phase synchronization calculation unit 44 illustrated in FIG. 5. The phase synchronization calculation unit 44 includes a phase error calculation unit 441, a proportional integral (PI) controller 442, an integrator 443, and proportioners 444 and 445.

The phase error calculation unit 441 receives the α-axis AC component α and the β-axis AC component β output from the three-to-two phase converter 43 and the estimated rotor position 2θ\hat{ } output from the integrator 443. The phase error calculation unit 441 calculates the phase error Δi_{AC}*Δ2θ according to Formula (19) below. The phase error calculation unit 441 outputs the calculated phase error Δi_{AC}*Δ2θ to the PI controller 442.

$$\begin{matrix}Formula 19 & \\ \begin{matrix}Δ {i}_{A C} * Δ2θ := α sin 2 \hat{θ} - β cos 2 \hat{θ} = Δ {i}_{A C} sin ( 2 θ - 2 \hat{θ} ) \\ ≅ Δ {i}_{AC} ( 2 θ - 2 \hat{θ} ) = Δ {i}_{AC} * Δ 2 θ\end{matrix} & ( 19 )\end{matrix}$$

Here, “Δi_{AC}” in Formula (19) is expressed by Formula (20) below.

$$\begin{matrix}Formula 20 & \\ Δ {i}_{A C} = \vert \frac{1}{A} \frac{{L}_{1}}{{L}_{0}} \vert & ( 20 )\end{matrix}$$

The PI controller 442 receives input of the phase error Δi_{AC}*Δ2θ output from the phase error calculation unit 441. The PI controller 442 outputs the estimated speed 2ω\ddot{ } such that the phase error Δi_{AC}*Δ2θ becomes zero.

The integrator 443 integrates the estimated speed 2ω\hat{ } output from the PI controller 442 and outputs the integrated value as the estimated rotor position 2θ\hat{ }. The estimated rotor position 2θ\hat{ } output by the integrator 443 is fed back to the phase error calculation unit 441.

In Formula (19) above, when “2θ>2θ\ddot{ }”, the phase error Δi_{AC}*Δ2θ is a positive value, and thus the estimated speed 2ω\ddot{ } and the estimated rotor position 2θ are corrected in an increasing direction. When “2θ\ddot{ }<2θ\ddot{ }”, the phase error Δi_{AC}*Δ2θ is a negative value, and thus the estimated speed 2ω\ddot{ } and the estimated rotor position 2θ\ddot{ } are corrected in a decreasing direction. Finally, “2θ=2θ\ddot{ }” is achieved, and the phase and frequency of the AC component of the current differential information of the rotary machine 1 are estimated. In this manner, the phase synchronization calculation unit 44 takes the form of a phase locked loop (PLL).

The phase synchronization calculation unit 44 inputs the estimated rotor position 2θ\ddot{ } to the proportioner 444 and multiplies the estimated rotor position 2θ\ddot{ } by 0.5 to calculate the estimated rotor position θ\ddot{ }. In addition, the phase synchronization calculation unit 44 inputs the estimated speed 2ω\ddot{ } to the proportioner 445 and multiplies the estimated speed 2ω\ddot{ } by 0.5 to calculate the estimated speed ω\ddot{ }.

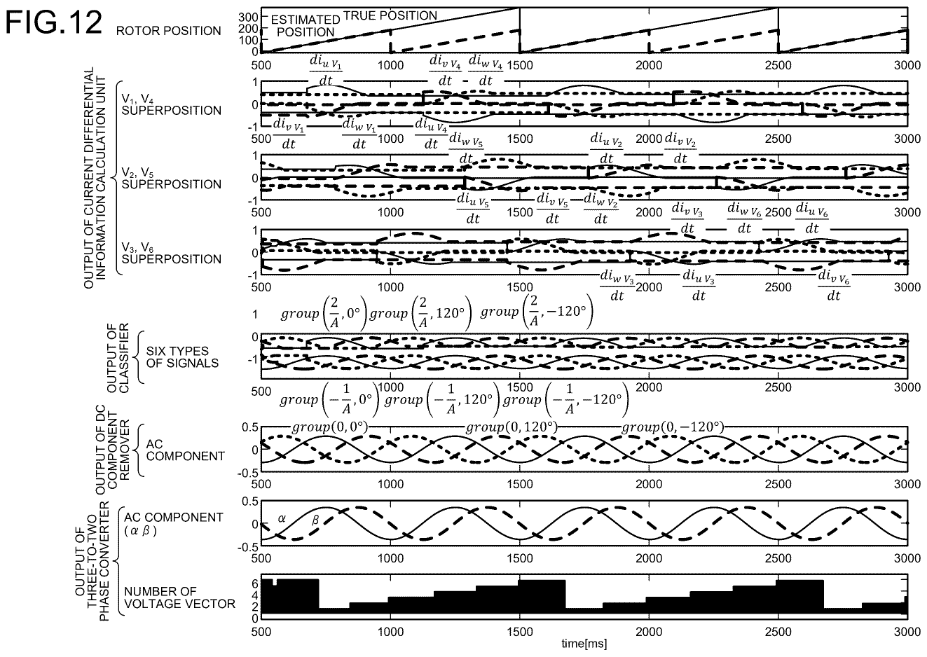

FIG. 12 is a diagram illustrating output of each unit of the position estimator 4 illustrated in FIG. 5. In FIG. 12, the operation condition is the same as that in FIG. 8, and the current differential information is fragmentary. The first row “rotor position” from the top in FIG. 12 shows the true position of the rotor and the estimated position output by the phase synchronization calculation unit 44. The second to fourth rows from the top in FIG. 12 show the outputs of the current differential information calculation unit 40. The fifth row from the top in FIG. 12 shows the output of the classifier 41. The sixth row from the top in FIG. 12 shows the output of the DC component remover 42. The seventh row from the top in FIG. 12 shows the output of the three-to-two phase converter 43. The eighth row from the top in FIG. 12 shows the number of the voltage vector applied at each time point. In FIG. 12, similarly to FIG. 8, the voltage vectors of V0 and V7 are numbered zero for the sake of explanation.

From FIG. 12, it can be known that the classifier 41 generates six types of signals based on the classification illustrated in FIG. 9. In addition, the output of the DC component remover 42 is an orthogonal-biaxially expressed AC component having a DC component of zero and vibrating at a double angle of the rotor position. The position estimator 4 estimates the rotor position by performing phase synchronization calculation on the output of the three-to-two phase converter 43.

Returning to FIG. 1, the three-to-two phase converter 9 of the controller 5 receives input of the rotary machine currents iᵤ, iᵥ, and i_{w} detected by the current detector 2. The three-to-two phase converter 9 converts the rotary machine currents iᵤ, iᵥ, and i_{w} in a three-phase coordinate system into rotary machine currents i_{α} and i_{β} in a stationary two-phase coordinate system. The three-to-two phase converter 9 outputs the rotary machine currents i_{α} and i_{β} to the rotating coordinate converter 10.

The rotating coordinate converter 10 receives input of the rotary machine currents i_{α} and i_{β} output from the three-to-two phase converter 9 and the estimated rotor position θ\ddot{ } output from the position estimator 4. Using the estimated rotor position θ\ddot{ }, the rotating coordinate converter 10 converts the rotary machine currents i_{α} and i_{β} in a stationary two-phase coordinate system into rotary machine currents i_{d} and i_{q} in a rotating coordinate system. The rotating coordinate converter 10 outputs the rotary machine currents i_{d} and i_{q} to the current controller 6.

The current controller 6 receives input of the rotary machine current commands i_{d}* and i_{q}* and the rotary machine currents i_{d} and i_{q}. The rotary machine current command i_{d}* is a d-axis drive current command indicating a d-axis armature current component that minimizes the magnetic resistance of the rotor of the rotary machine 1. The rotary machine current i_{q}* is a q-axis drive current command indicating a one-axis armature current component which is a direction orthogonal to the d axis. The current controller 6 performs current control such that the rotary machine currents i_{d} and i_{q} output from the rotating coordinate converter 10 comply with the rotary machine current commands i_{d}* and i_{q}*, and calculates rotary machine voltage commands v_{d}* and v_{q}* in a rotating coordinate system. The current control in the current controller 6 is, for example, PI control. The current controller 6 outputs the rotary machine voltage commands v_{d}* and v_{q}*, which are calculation results, to the rotating coordinate inverse converter 7.

The rotating coordinate inverse converter 7 receives input of the rotary machine voltage commands v_{d}* and v_{q}* and the estimated rotor position θ\hat{ }. The rotating coordinate inverse converter 7 uses the estimated rotor position θ\ddot{ } to convert the rotary machine voltage commands v_{d}* and v_{q}* in a rotating coordinate system calculated by the current controller 6 into voltage commands v_{α}* and v_{β}* in a stationary two-phase coordinate system. The rotating coordinate inverse converter 7 outputs the rotary machine voltage commands v_{α}* and v_{β}* to the two-to-three phase converter 8.

The two-to-three phase converter 8 receives input of the rotary machine voltage commands v_{α}* and v_{β}*. The two-to-three phase converter 8 converts the rotary machine voltage commands v_{α}* and v_{β}* in a stationary two-phase coordinate system into rotary machine voltage commands vᵤ*, vᵥ*, and v_{w}* in a three-phase coordinate system for driving the rotary machine 1.

As described above, the control device 100 according to the first embodiment is the control device 100 that performs drive control of the rotary machine 1 that is a multiphase rotary machine, and includes the current detector 2 that is a current detection unit that detects a rotary machine current flowing through the rotary machine 1, the controller 5 that is a drive voltage command calculation unit that generates a drive voltage command for driving the rotary machine 1 based on the rotary machine current and information on the rotor position of the rotary machine 1, the voltage applicator 3 that applies a voltage to the rotary machine 1 based on the drive voltage command generated, and the position estimator 4 that is a position estimation unit that estimates the rotor position based on the rotary machine current detected by the current detector 2. The position estimator 4 determines the type of the voltage vector output from the voltage applicator 3 based on the gate signals Gᵤ, Gᵥ, and G_{w} of the voltage applicator 3, calculates current differential information that is a change amount of the rotary machine current for each type of the voltage vector determined, generates an AC signal having a DC component of zero and changing at a double angle of the rotor position based on the rotary machine current change amount that is a calculation result, and estimates the rotor position based on the AC signal generated. With such a configuration, even in an appearance pattern of effective voltage vectors in which the current differential information is fragmentary, the control device 100 can estimate the rotor position with high accuracy by generating a continuous AC signal having a DC component of zero and vibrating at a double angle of the rotor position based on the fragmentary current differential information.

The position estimator 4 can estimate the rotor position, for example, by performing phase synchronization calculation on the AC signal generated as described above. In addition, the position estimator 4 generates an AC signal having a continuous waveform shape based on a combination of a plurality of pieces of current differential information including a same waveform shape among a plurality of pieces of current differential information obtained under a plurality of conditions that differ in at least one of voltage vector or phase. More specifically, utilizing a feature that two pieces of current differential information, which are obtained under a condition that directions of voltage vectors are in an opposite-direction relationship and with a same phase, have a relationship of reverse signs, the position estimator 4 can generate a continuous AC signal by using a value obtained by multiplying, by minus one, one of the two pieces of current differential information obtained under a condition that directions of voltage vectors are in an opposite-direction relationship and with a same phase.

The position estimator 4 can generate a continuous AC signal utilizing a feature that the phase of the AC component of the current differential information is shifted according to the direction of the voltage vector.

In addition, as shown in Formulas (10) to (14) above, the position estimator 4 can calculate the DC component of the current differential information by taking the sum of first current differential information, second current differential information having a phase difference of plus ⅔ π from the first current differential information, and third current differential information having a phase difference of minus ⅔ π from the first current differential information.

In addition, the position estimator 4 includes the phase error calculation unit 441 that calculates a phase error based on an AC signal having a DC component of zero and changing at a double angle of the rotor position, and based on an estimated position of the rotor position, the PI controller 442 that is an estimated speed generation unit that outputs an estimated speed based on the phase error, and the integrator 443 that outputs a value obtained by integrating the estimated speed as the estimated position.

### Second Embodiment

The control device 100 according to the second embodiment has a configuration similar to that in the first embodiment. In the second embodiment, the overall configuration of the control device 100 is similar to the configuration illustrated in FIG. 1, and the configuration of the position estimator 4 is similar to the configuration illustrated in FIG. 5. Therefore, in the second embodiment, reference signs identical to those in the first embodiment will be used for description. However, the second embodiment is different from the first embodiment in the processing content performed by the DC component remover 42 illustrated in FIG. 5. Hereinafter, differences from the first embodiment will be mainly described.

In the second embodiment, the DC component remover 42 calculates the DC component “1/A” using Formulas (21) to (23) below instead of Formulas (10) to (14) above.

$$\begin{matrix}Formula 21 & \\ \frac{1}{A} = \frac{1}{3} \{ group ( \frac{2}{A} , 0 ° ) - group ( - \frac{1}{A} , 0 ° ) \} & ( 21 )\end{matrix}$$

$$\begin{matrix}Formula 22 & \\ \frac{1}{A} = \frac{1}{3} \{ group ( \frac{2}{A} , 120 ° ) - group ( - \frac{1}{A} , 120 ° ) \} & ( 22 )\end{matrix}$$

$$\begin{matrix}Formula 23 & \\ \frac{1}{A} = \frac{1}{3} \{ group ( \frac{2}{A} , - 120 ° ) - group ( - \frac{1}{A} , - 120 ° ) \} & ( 23 )\end{matrix}$$

In Formulas (21) to (23), the DC component “1/A” is calculated by taking a difference between signals that are different in DC component and equal in AC component reference phase among the outputs of the classifier 41. Here, the three Formulas (21) to (23) are shown, but the DC component remover 42 only needs to use at least one formula that uses the latest effective voltage vector and the nearest effective voltage vector having a different number from the latest effective voltage vector. Here, for example, group (2/A, 0°) is generated based on current differential information at the time when the effective voltage vector V1 or V4 is applied, and group (−1/A, 0°) is generated based on current differential information at the time when the effective voltage vector V2 or V3 or V5 or V6 is applied. Therefore, Formula (21) can be said to be a formula that uses the effective voltage vectors V1 or V4, and V2 or V3 or V5 or V6. Similarly, Formula (22) is a formula that uses the effective voltage vectors V2 or V5, and V1 or V3 or V4 or V6. Formula (23) is a formula that uses the effective voltage vectors V3 or V6, and V1 or V2 or V4 or V5.

For example, when the latest effective voltage vector and the nearest effective voltage vector having a different number from the latest effective voltage vector are the effective voltage vectors V1 and V2, the calculation is performed using at least one of Formulas (21) and (22) that use the effective voltage vectors V1 and V2. Similarly to the first embodiment, when a plurality of formulas are used, the DC component remover 42 can calculate the DC component “1/A” by using an average value of calculation results of the plurality of formulas. As described above, in the second embodiment, the processing of extracting the DC component is different from that in the first embodiment, and the other processing is similar to that in the first embodiment. In the second embodiment, similarly to the first embodiment, even in an appearance pattern of effective voltage vectors in which the current differential information is fragmentary, the control device 100 can estimate the rotor position with high accuracy by generating a continuous AC signal having a DC component of zero and vibrating at a double angle of the rotor position from the fragmentary current differential information.

With Formulas (10) to (14) used in the first embodiment, three signals are required among the outputs of the classifier 41. On the other hand, with Formulas (21) to (23) used in the second embodiment, the DC component “1/A” can be calculated using two signals among the outputs of the classifier 41. Therefore, the second embodiment can obtain the effect of reducing the calculation load as compared with the first embodiment. Furthermore, while the method using Formulas (21) to (23) requires application of two types of voltage vectors, the method using Formulas (10) to (14) requires application of two or three types of voltage vectors. From the viewpoint of position estimation response, the fewer types of voltage vectors are used for calculation produces, the better a responsiveness becomes. Therefore, in the second embodiment, it is possible to extract the DC component with high response as compared with the method of the first embodiment.

Next, a hardware configuration for implementing each function of the control device 100 according to the first embodiment and the second embodiment will be described. Each function as used herein refers to the functionality of the current detector 2, the voltage applicator 3, the position estimator 4, and the controller 5.

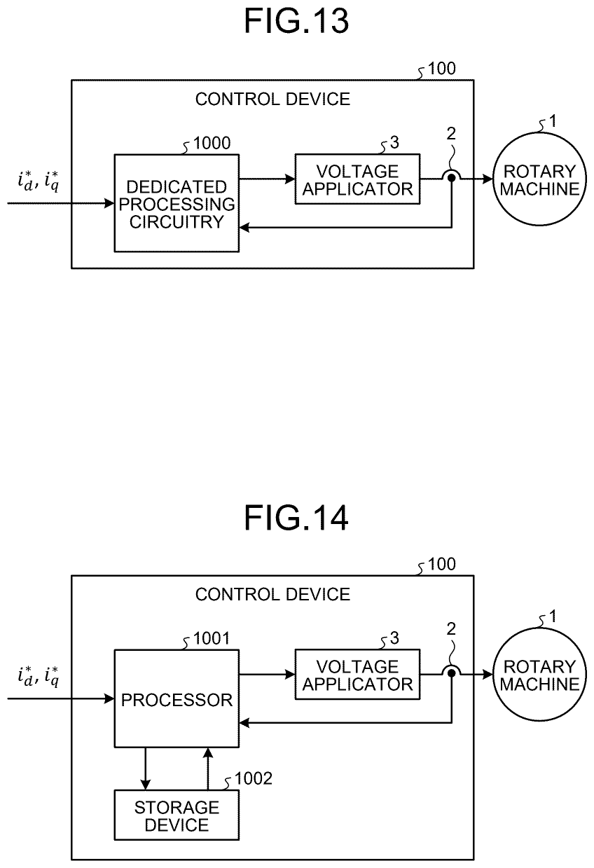

FIG. 13 is a diagram illustrating a first example of a hardware configuration for implementing the functions of the control device 100 according to the first embodiment and the second embodiment. FIG. 14 is a diagram illustrating a second example of a hardware configuration for implementing the functions of the control device 100 according to the first embodiment and the second embodiment. In the first example illustrated in FIG. 13, the control device 100 includes a dedicated processing circuitry 1000, a current detector 2, and a voltage applicator 3. Here, the functions of the current detector 2 and the voltage applicator 3 are implemented by using dedicated hardware, and the functions of the position estimator 4 and the controller 5 are implemented by the dedicated processing circuitry 1000. In the second example illustrated in FIG. 14, the control device 100 includes a processor 1001, a storage device 1002, the current detector 2, and the voltage applicator 3. Here, the functions of the current detector 2 and the voltage applicator 3 are implemented by using dedicated hardware, and the functions of the position estimator 4 and the controller 5 are implemented by the processor 1001 and the storage device 1002. The dedicated processing circuitry 1000 and the processor 1001 are also referred to as a control circuit.

The dedicated processing circuitry 1000 is a single circuit, a composite circuit, a programmed processor, a parallel programmed processor, an application specific integrated circuit (ASIC), a field programmable gate array (FPGA), or a combination thereof. The control device 100 may collectively implement the above-described functions by one piece of dedicated processing circuitry 1000, or may implement the above-described functions by using a plurality of pieces of dedicated processing circuitry 1000.

The processor 1001 can implement each function of the control device 100 by reading and executing a program stored in the storage device 1002. Note that the control device 100 may include a plurality of processors 1001 and a plurality of storage devices 1002 that cooperate to implement the above functions.

In a case where the processor 1001 and the storage device 1002 are used, the above functions are implemented by software, firmware, or a combination thereof. Software or firmware is described as programs and stored in the storage device 1002. The processor 1001 reads and executes the programs stored in the storage device 1002. It can also be said that these programs cause a computer to execute the procedures and methods for executing each function.

The processor 1001 is a CPU, and is also called a processing device, an arithmetic device, a microprocessor, a microcomputer, a digital signal processor (DSP), or the like. Examples of the storage device 1002 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAN), a read only memory (ROM), a flash memory, an erasable programmable ROM (EPROM), an electrically EPROM (EEPROM, registered trademark), and the like.

The configurations described in the above-mentioned embodiments indicate examples. The embodiments can be combined with another well-known technique and with each other, and some of the configurations can be omitted or changed in a range not departing from the gist.

For example, in the first and second embodiments described above, the rotary machine 1 is a synchronous reluctance motor, but the type of the rotary machine 1 is not limited thereto. The rotary machine 1 may be a motor having saliency such as an interior permanent magnet synchronous motor or a surface permanent magnet synchronous motor (SPMSM).

In the first and second embodiments, the controller 5 of the control device 100 controls the d-axis current and the q-axis current. However, the controller 5 may be configured to control torque, rotational speed, and the like.

In the first and second embodiments, the configuration in which the current detector 2 detects the phase current of the rotary machine 1 has been described, but the current detector 2 is an example of a current detection unit and is not limited to the above example. The current detection unit only needs to be able to detect the phase current, and may be a current sensor incorporated in an inverter (not illustrated) constituting the voltage applicator 3.

### REFERENCE SIGNS LIST

1 rotary machine; 2 current detector; 3 voltage applicator; 4 position estimator; 5 controller; 6 current controller; 7 rotating coordinate inverse converter; 8 two-to-three phase converter; 9, 43 three-to-two phase converter; 10 rotating coordinate converter; 30a transistor; 30b diode; 30A, 30B, 30C leg; 32, 33, 34 connection point; 35a, 35b DC bus; 36 power source; 40 current differential information calculation unit; 41 classifier; 42 DC component remover; 44 phase synchronization calculation unit; 100 control device; 400 voltage vector determiner; 401 current differential calculator; 441 phase error calculation unit; 442 PI controller; 443 integrator; 444, 445 proportioner; 1000 dedicated processing circuitry; 1001 processor; 1002 storage device; UP, UN, VP, VN, WP, WN semiconductor element.

1. A control device that performs drive control of a multiphase rotary machine, the control device comprising:
current detection circuitry to detect a rotary machine current flowing through the rotary machine;
drive voltage command calculation circuitry to generate a drive voltage command for driving the rotary machine based on the rotary machine current and an estimated value of a rotor position of the rotary machine;
voltage application circuitry to apply a voltage to the rotary machine based on the drive voltage command generated; and
position estimation circuitry to estimate the rotor position based on the rotary machine current, wherein
the position estimation circuitry determines a type of a voltage vector output from the voltage application circuitry based on a gate signal of the voltage application circuitry, calculates a change amount of the rotator current for each type of the voltage vector determined, generates an AC signal having a DC component of zero and changing at a double angle of the rotor position based on a rotary machine current change amount that is a calculation result, and estimates the rotor position based on the AC signal.

2. The control device according to claim 1, wherein
the position estimation circuitry estimates the rotor position by performing phase synchronization calculation on the AC signal.

3. The control device according to claim 1, wherein
the position estimation circuitry generates the AC signal having a continuous waveform shape based on a combination of a plurality of the rotary machine current change amounts including a same waveform shape among a plurality of the rotary machine current change amounts obtained under a plurality of conditions that differ in at least one of voltage vector or phase.

4. The control device according to claim 3, wherein
utilizing a feature that the two rotary machine current change amounts obtained under a condition that directions of voltage vectors are in an opposite-direction relationship and with a same phase have a relationship of reverse signs, the position estimation circuitry generates the AC signal by using a value obtained by multiplying, by minus one, one of the two rotary machine current change amounts obtained under a condition that directions of voltage vectors are in an opposite-direction relationship and with a same phase.

5. The control device according to claim 3, wherein
the position estimation circuitry generates the AC signal utilizing a feature that a phase of an AC component of the rotary machine current change amount is shifted according to a direction of a voltage vector.

6. The control device according to claim 3, wherein
the position estimation circuitry calculates a DC component of the rotary machine current change amount, calculates an AC component of the rotary machine current change amount by subtracting the DC component calculated from the rotary machine current change amount, and generates the AC signal based on the AC component.

7. The control device according to claim 6, wherein
the position estimation circuitry calculates the DC component by taking a sum of a first rotary machine current change amount, a second rotary machine current change amount having a phase difference of plus ⅔ π from the first rotary machine current change amount, and a third rotary machine current change amount having a phase difference of minus ⅔ π from the first rotary machine current change amount, among the rotary machine current change amounts.

8. The control device according to claim 6, wherein
the position estimation circuitry calculates the DC component by taking a difference between the two rotary machine current change amounts that are equal in phase of the AC component and different in magnitude of the DC component, among the rotary machine current change amounts.

9. The control device according to claim 1, wherein
the position estimation circuitry includes:
phase error calculation circuitry to calculate a phase error based on an AC signal having a DC component of zero and changing at a double angle of the rotor position, and based on an estimated position of the rotor position;
estimated speed generation circuitry to output an estimated speed based on the phase error; and
integration circuitry to output a value obtained by integrating the estimated speed as the estimated position.

10. A drive control method for a multiphase rotary machine, the drive control method comprising:
detecting a rotary machine current flowing through the rotary machine;
generating a drive voltage command for driving the rotary machine based on the rotary machine current and an estimated value of a rotor position of the rotary machine;
applying a voltage to the rotary machine based on the drive voltage command generated; and
estimating the rotor position based on the rotary machine current, wherein
in estimating the rotor position, a type of a voltage vector output from a voltage application circuitry that applies a voltage to the rotary machine is determined based on a gate signal of the voltage application circuitry, a change amount of the rotator current is calculated for each type of the voltage vector determined, an AC signal having a DC component of zero and changing at a double angle of the rotor position is generated based on a rotary machine current change amount that is a calculation result, and the rotor position is estimated based on the AC signal.
